(19) United States
(12) Patent Application Publication
(10) Pub. No.: US 2016/0169764 A1
(43) Pub. Date: Jun. 16, 2016

(54) SYSTEM AND METHOD FOR PRE-VERIFYING STABILITY OF 3D PRINTING OUTPUT

(71) Applicant: Electronics and Telecommunications Research Institute, Daejeon (KR)

(72) Inventors: Kap Kee KIM, Daejeon (KR); Chang Woo CHU, Daejeon (KR); Jin Sung CHOI, Daejeon (KR)

(21) Appl. No.: 14/721,060

(22) Filed: May 26, 2015

(30) Foreign Application Priority Data
Dec. 16, 2014 (KR) 10-2014-0181670

(51) Int. Cl. G01M 1/00; B29C 67/00

(52) U.S. Cl. CPC G01M 1/00; B29C 67/0051; B33Y 30/00

(57) ABSTRACT

Provided are a system and method for pre-verifying stability such that a 3D printing output can be balanced on the center thereof even without a support or a fixture. The system for pre-verifying stability of a 3D printing output includes a slicing unit configured to slice a 3D object, a distance map creating unit configured to create a distance map of each plane obtained by slicing the 3D object, a safety zone searching unit configured to search for a stability safety zone of the sliced 3D object, a stability verifying unit configured to verify stability of the 3D object using the stability safety zone, and a stability securing unit configured to determine a position of an inner mesh of the 3D object.

### CROSS-REFERENCE TO RELATED APPLICATIONS

This application claims priority under 35 U.S.C. §119 to Korean Patent Application No. 10-2014-0181670, filed on Dec. 16, 2014, the disclosure of which is incorporated herein by reference in its entirety.

### TECHNICAL FIELD

The present invention relates to a system and method for pre-verifying stability such that a 3D printing output may be balanced on the center thereof even without a support or a fixture.

### BACKGROUND

A 3D printer is a machine for printing a 3D stereoscopic article according to a previously input blueprint. That is, a 3D printer is a device capable of creating an actual object in a 3D space as if it is printed on paper, providing that a 3D blueprint is present.

At an initial stage of development, a material of a 3D printer was limited to a plastic material, but recently, with popular products introduced, the range of materials has extended to nylon, metal.

A 3D printing technique is divided into a fused deposition modeling (FDM) (an additive type or a rapid prototyping type) and an extrusion deposition (computer numerical control (CNC) milling type) depending on a scheme in which a 3D form is created.

The FDM is a scheme of creating a 3D form by laying powder (powder of plaster or nylon), a plastic liquid, or a plastic yarn as layers having a thickness ranging from 0.01 to 0.08 mm, thinner than paper. As the layers are thinner, a more precise shape may be obtained and coloration may be simultaneously performed.

The extrusion deposition is a scheme of creating a 3D image by cutting a large mass as if it is curved. Compared with the FDM, the extrusion deposition is advantageous in that a product is more precise than that of the FDM, but a large amount of material is consumed. It is difficult to manufacture an inwardly dug shape like a cup, and a coloring operation should be performed separately.

A related art technique for securing stability of a 3D printing output is divided into a technique field in which whether a 3D printing output can be held in advance and a technique field in which a 3D object is changed so as to be held when it is difficult to hold a 3D printing output.

Here, the stability verifying technique is automatically performed, while the technique enabling a 3D object to have stability after printing includes an automatic scheme and a manual scheme.

In order to verify stability, in general, the center of mass is used, and it is determined whether a 3D object can be stably held by using a relationship between the center of mass and a zone in which the 3D object is in contact with a plane on which the 3D object stands. However, in the related art, when a material of a 3D printer is different, or materials are mixed, such stability cannot be measured accurately.

As a technique for securing stability, a 3D object deformation technique has been proposed, and a subject to be deformed is divided into an interior (inner carving) and an exterior (shape deformation).

As for the inner carving, since an inner carved shape cannot be viewed from the outside, most 3D object deformation employs the inner carving scheme.

As for the shape deformation, since a user has leeway to change an intention of a design, and thus, the shape deformation is limitedly used.

If, however, a 3D object has a dynamic posture so it is difficult to secure stability of a 3D printing output only with inner carving, both inner carving and shape deformation are used, and the shape deformation used herein follows an automatic or manual scheme.

In the related art inner carving, an inner mesh of a 3D object is created and a thickness between an outer mesh and the inner mesh is processed.

In the related art inner carving, in general, inner carving is performed through voxelization. This scheme is easy to be realized, but since an inner shape is created regardless of an outer shape, stepwise thickness is created.

That is, when a source material of a 3D printer is transparent, such a stepwise shape is viewed from the outside.

Also, in the related art inner carving, since stability verification is performed by voxel, a calculation time is lengthened.

### SUMMARY

Accordingly, the present invention provides a system and method for pre-verifying stability of a 3D printing output regarding inner carving, which prevents creation of a stepwise inner mesh in a transparent material and reduces a calculation time required for verifying stability, when 3D printing is performed.

In one general aspect, a system for pre-verifying stability of a 3D printing output includes: a slicing unit configured to slice a 3D object; a distance map creating unit configured to create a distance map of each plane obtained by slicing the 3D object; a safety zone searching unit configured to search for a stability safety zone of the sliced 3D object; a stability verifying unit configured to verify stability of the 3D object using the stability safety zone; and a stability securing unit configured to determine a position of an inner mesh of the 3D object.

In another general aspect, a method for pre-verifying stability of a 3D printing output includes: slicing a 3D object; creating a distance map of each plane obtained by slicing the 3D object; searching for a stability safety zone of the 3D object; verifying of the 3D object using the stability safety zone; and securing stability by determining a position of an inner mesh of the 3D object.

Other features and aspects will be apparent from the following detailed description, the drawings, and the claims.

### BRIEF DESCRIPTION OF THE DRAWINGS

FIG. 1 is a block diagram illustrating a system for pre-verifying stability of a 3D printing output according to an embodiment of the present invention.

FIG. 2 is a view illustrating a process of slice processing and creating a distance map of the system for pre-verifying stability of a 3D printing output according to an embodiment of the present invention.

FIG. 3 is a flow chart illustrating a method for pre-verifying stability of a 3D printing output according to an embodiment of the present invention.

FIG. 4 is a detailed flow chart illustrating a method for pre-verifying stability of a 3D printing output according to an embodiment of the present invention.

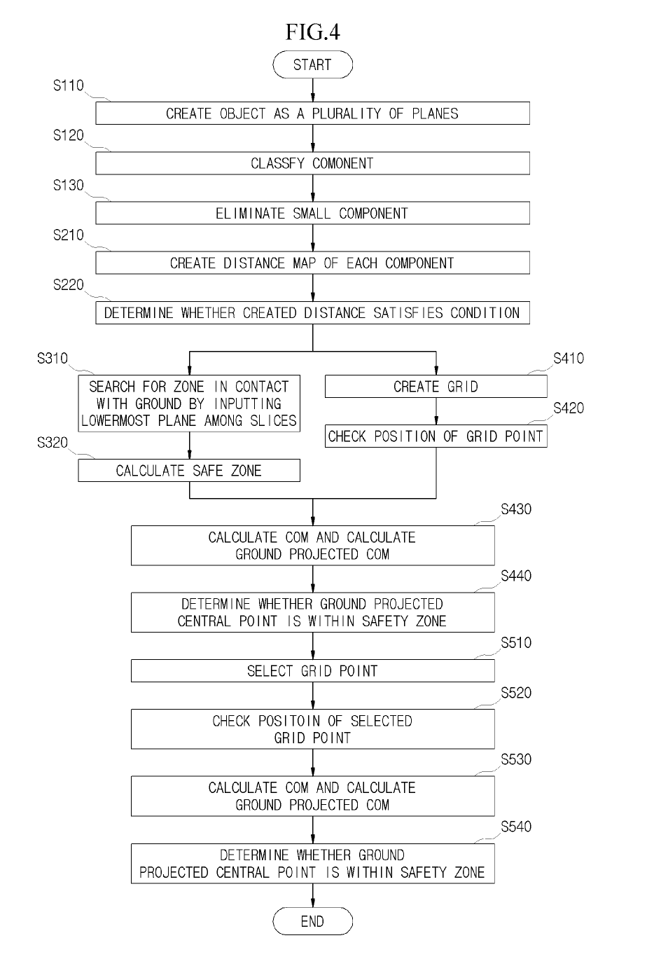

### DETAILED DESCRIPTION OF EMBODIMENTS

The advantages, features and aspects of the present invention will become apparent from the following description of the embodiments with reference to the accompanying drawings, which is set forth hereinafter.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A system for pre-verifying stability of a 3D printing output according to an embodiment of the present invention proposes an inner carving technique by components for creating thickness information of a 3D object, verifying stability, and securing stability.

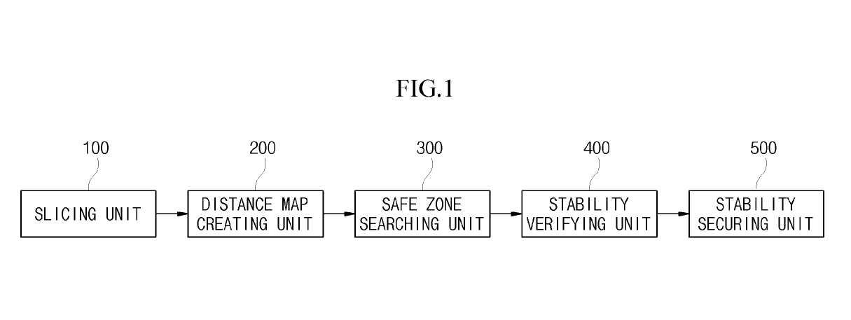

FIG. 1 is a block diagram illustrating a system for pre-verifying stability of a 3D printing output according to an embodiment of the present invention. The system for pre-verifying stability of a 3D printing output according to an embodiment of the present invention includes a slicing unit 100 and a distance map creating unit 200 as components for creating thickness information, and a safe zone searching unit 300 and a stability verifying unit 400 as components for verifying stability, and a stability securing unit 500 for determining a position of an inner mesh of a 3D object, as a component for securing stability.

The slicing unit 100 is a component for receiving a 3D object and slicing the same. The slicing unit 100 slices a 3D object into a plurality of planes and classifies components of each plane. Also, the slicing unit 100 eliminates a component smaller than a preset size, among the components, from a stability verification calculation process.

The distance map creating unit 200 calculates and creates a distance map of each component received from the slicing unit 100. Also, the distance map creating unit 200 determines whether a created distance satisfies preset internal and external conditions.

Here, the internal condition is checked by determining whether the created distance exceeds an outer edge of a component, and the external condition is checked by determining a first component includes a second component, among the planes including a plurality of components.

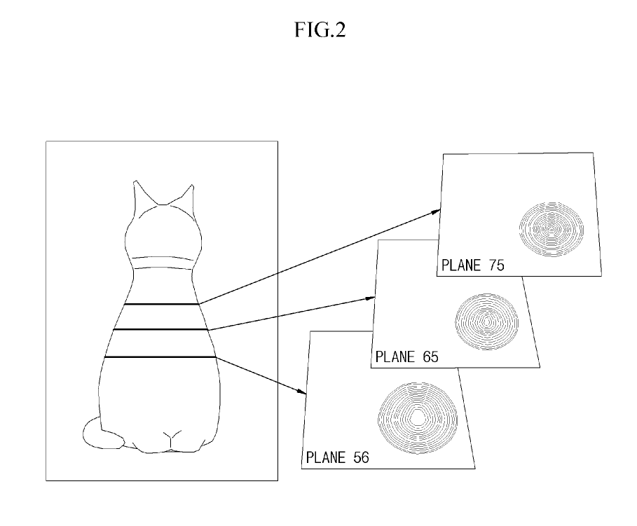

FIG. 2 is a view illustrating a process of slicing and creating a distance map of the system for pre-verifying stability of a 3D printing output according to an embodiment of the present invention. A size of a slice may be changed in design according to output resolution of a 3D printer, and a 3D object illustrated on the left of FIG. 2 is created by calculating distance maps of planes (for example, plane 75, plane 65, and plane 56) illustrated on the right of FIG. 2 according to slicing illustrated as horizontal lines passing through the 3D object.

The safe zone searching unit 300 and the stability verifying unit 400 searches a stability safe zone using the sliced planes, and verifies stability by calculating a center of mass (COM) and a ground projected central point of the COM.

The safety zone searching unit 300 and the stability verifying unit 400 according to an embodiment of the present invention use the sliced planes received from the component in the previous stage, and here, if a model with a thickness is input, a boundary may be checked in an interior and exterior checking step (a step of checking whether a grid point is within or outside of a component) performed by the stability verifying unit 400 and a corresponding processing may be performed.

The safety zone searching unit 300 and the stability verifying unit 400, components for verifying stability according to an embodiment of the present invention, search for a stability safety zone, calculate a COM, calculate a ground projected central point of the COM, determines whether the corresponding central point is included in the stability safety zone, and pre-verifies stability of a 3D printing output.

The safety zone searching unit 300 according to an embodiment of the present invention inputs a plane positioned in the lowermost end among the sliced planes, searches for a zone corresponding to a ground, and displays a minimum area zone including the searched zones, in a circular shape, thereby displaying a stability safety zone.

The stability verifying unit 400 according to an embodiment of the present invention creates grids at intervals between the sliced planes, determines whether a grid point is within or outside of a component, and calculates a COM using a grid point positioned within a component. Also, the stability verifying unit 400 calculates a ground protected central point of the COM and determines whether the corresponding central point is included in the stability safety zone calculated by the safety zone searching unit 300, thus verifying stability of the 3D printing output.

The stability securing unit 500, a component for securing stability according to an embodiment of the present invention, determines a position of an inner mesh of the 3D object. The stability securing unit 500 determines a distance corresponding to a final inner mesh, among a plurality of candidate distances included in the distance map, by each plane, and determines a position of the inner mesh of the 3D object.

Here, the stability securing unit 500 selects a changed grid point in 3D printing, determines whether such a grid point is within or outside of a component, calculates a new COM using the grid point positioned within the component, calculates a ground projected central point of the calculated COM, and sequentially determines whether the corresponding central point is positioned within the stability safety zone.

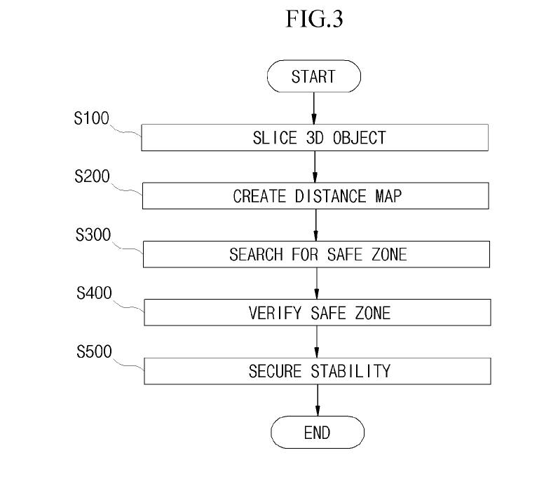

FIG. 3 is a flow chart illustrating a method for pre-verifying stability of a 3D printing output according to an embodiment of the present invention, and FIG.

4 is a detailed flow chart illustrating a method for pre-verifying stability of a 3D printing output according to an embodiment of the present invention.

The method for pre-verifying stability of a 3D printing output according to an embodiment of the present invention includes a step (S100) of slicing a 3D object, step (S200) of creating a distance map of each plane obtained by slicing the 3D object, step (S300) of searching for a stability safety zone of the 3D object, step (S400) of verifying stability of the 3D object using the stability safety zone, and step (S500) of determining a position of an inner mesh of the 3D object to secure stability.

In step S100, the 3D object is sliced into a plurality of planes in step S110 and components of the sliced planes are classified in step S120. Among the classified components, a component smaller than a preset size is eliminated from a stability verification calculation process (to be described hereinafter) in step S130.

In step S200, an available distance map of each component is calculated to be created in step S210, and it is determined whether the created distance satisfies preset internal and external conditions in step S220.

Here, the internal condition in step S220 is checked by determining whether a created distance exceeds an outer edge of a component, and the external condition in step S220 is checked by determining whether a first component includes a second component, among the planes including a plurality of components.

In step S300, a plane positioned in the lowermost end with respect to a ground, among the sliced planes, is input and a zone corresponding to the ground is searched in step S310, and a stability safety zone including a minimum area, among the zones, is calculated and displayed in step S320.

In step S400, grids are created at intervals between the planes in step 5410, and it is determined whether a grid point is positioned within a component in step S420.

In step S430, the stability safety zone calculated in step S320 is received, information regarding the grid point positioned within the component in step S420 is received, a COM is calculated using the grid point, and a ground projected central point of the corresponding COM is calculated.

In step S440, it is determined whether the ground projected central point of the COM calculated in step S430 is included in the stability safety zone to pre-verify stability.

In step S500, a position of an inner mesh of the 3D object is determined Specifically, in step S510, a changed grid point in 3D printing is selected in step MO, it is determined whether the selected grid point is within or outside of a component in step S520, a new COM is calculated using the grid point positioned within the component and a ground projected central point of the calculated COM is calculated in step S530, and it is determined whether the corresponding central point is positioned within the stability safety zone in step S540. That is, in steps S510 through S540 according to an embodiment of the present invention, a distance corresponding to a final inner mesh, among a plurality of candidate distances included in a distance map, is determined for each plane, and a position of the inner mesh of the 3D object is determined

Compared with the related art voxelization technique, the system and method for pre-verifying stability of a 3D printing output according to an embodiment of the present invention can prevent creation of a stepwise inner mesh in a transparent material in 3D printing, and uniformly reduce a calculation time in verifying stability.

Also, according to an embodiment of the present invention, in realizing stability of a structure using 3D printing, an internal surface maintaining the same shape as the exterior can be formed in inner carving, and since the number of objects for verifying stability is reduced through processing in units of planes, stability can be rapidly verified.

Advantages and effects of the present disclosure are not limited to the foregoing contents and any other technical effects not mentioned herein may be easily understood by a person skilled in the art from the foregoing description.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for pre-verifying stability of a 3D printing output, the system comprising:
a slicing unit configured to slice a 3D object;
a distance map creating unit configured to create a distance map of each plane obtained by slicing the 3D object;
a safety zone searching unit configured to search for a stability safety zone of the sliced 3D object;
a stability verifying unit configured to verify stability of the 3D object using the stability safety zone; and
a stability securing unit configured to determine a position of an inner mesh of the 3D object.

2. The system of claim 1, wherein the slicing unit slices the 3D object into a plurality of planes, and classifies a component of each slice.

3. The system of claim 2, wherein the slicing unit eliminates a component smaller than a preset size among the components from a stability verification calculation process.

4. The system of claim 2, wherein the distance map creating unit calculates and creates a distance map of each plane, and determines whether each calculated distance satisfies a preset condition.

5. The system of claim 2, wherein the safety zone searching unit searches for a plane positioned in the lowermost end with respect to a ground among the planes obtained by slicing the 3D object, and a zone to which the ground corresponds.

6. The system of claim 5, wherein the safety zone searching unit displays a stability safety zone including a minimum area of the zone.

7. The system of claim 2, wherein the stability verifying unit creates grids at intervals between the sliced planes, determines whether a grid point is within a component, calculates a ground projected central point of a center of mass (COM) calculated by using the grid point positioned within the component, and determines whether the calculated ground projected central point is included in the stability safety zone, thus verifying stability of the 3D printing.

8. The system of claim 2, wherein the stability securing unit determines a distance corresponding to a final inner mesh, among a plurality of candidate distances included in the distance map, according to each plane, and determines a position of the inner mesh of the 3D object.

9. A method for pre-verifying stability of a 3D printing output, the method comprising:
(a) slicing a 3D object;
(b) creating a distance map of each plane obtained by slicing the 3D object;
(c) searching for a stability safety zone of the 3D object;
(d) verifying of the 3D object using the stability safety zone; and
(e) securing stability by determining a position of an inner mesh of the 3D object.

10. The method of claim 9, wherein step (a) comprises slicing the 3D object into a plurality of planes and classifying components of the sliced planes.

11. The method of claim 10, wherein step (a) comprises eliminating a component smaller than a preset size, among the classified components, from a stability verification calculation process.

12. The method of claim 10, wherein steep (b) comprises calculating and creating a distance map of each plane and determining whether each calculated distance satisfies preset internal and external conditions.

13. The method of claim 10, wherein step (c) comprises inputting a plane positioned in the lowermost end with respect to a ground among the planes and searching for a zone corresponding to the ground.

14. The method of claim 13, wherein step (c) comprises displaying a stability safety zone including a minimum area of the zone.

15. The method of claim 10, wherein step (d) comprises creating grids at intervals between the planes, determining whether a grid point is positioned within a component, calculating a ground projected central point of a center of mass (COM) calculated by using the grid point positioned within the component, and determining whether the calculated ground projected central point is included in the stability safety zone.

16. The method of claim 10, wherein step (e) comprises determining a position of an inner mesh of the 3D object by determining a distance corresponding to a final inner mesh of each plane among candidate distances included in the distance map.
